(19) United States
(12) Patent Application Publication
(10) Pub. No.: US 2026/0342579 A1
(43) Pub. Date: Oct. 29, 2026

(54) SYSTEM AND METHOD FOR USAGE-BASED SEEDING OF PRE-STORED HIDDEN AUTHORIZATION CODES FOR HIGH EXPOSURE COMMUNICATIONS INITIATED USING THIRD PARTY DEVICES IN LIMITED NETWORK CONNECTIVITY ENVIRONMENTS

(71) Applicant: BANK OF AMERICA CORPORATION, Charlotte, NC (US)

(72) Inventors: Susan Moss, Vestal, NY (US); Sam William Christian, Secunderabad, Telangana (IN); Kiran Pulla, Hyderabad, Telangana (IN)

(73) Assignee: BANK OF AMERICA CORPORATION, Charlotte, NC (US)

(21) Appl. No.: 19/061,578

(22) Filed: Feb. 24, 2025

(51) Int. Cl. H04L 9/32; H04L 9/08

(52) U.S. Cl. CPC H04L 9/3226; H04L 9/0852; H04L 9/0894

(57) ABSTRACT

Embodiments of the present invention provide a system for usage-based seeding of pre-stored hidden authorization codes for high exposure communications initiated using third party devices in limited network connectivity environments. The system is configured to identify initiation of a communication, via a resource distribution device, by a user using a third party device, determine that the communication requires authorization, initiate authorization of the communication initiated by the user by causing an entity application stored on the user device to extract an authentication code stored in a secure vault of the user device, automatically populate the authentication code on the third party device, and determine that the authentication code matches an entity generated authentication code, where the entity generated authentication code is transmitted by the entity associated with the user, determine that the authorization of the communication is successful, and complete the communication initiated by the user, via the user device.

### BACKGROUND

There exists a need for a system that can authenticate users for performing high exposure communications using third party devices in a limited network connectivity environment.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for usage-based seeding of pre-stored hidden authorization codes for high exposure communications initiated using third party devices in limited network connectivity environments. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention identifies a third party device at a third party entity location, via a user device of a user, identifies initiation of a communication, via a resource distribution device, by the user using the third party device, determines that the communication requires authorization, causes the user device to establish a communication link with the third party device, initiates authorization of the communication initiated by the user by causing an entity application provided by an entity associated with the user that is stored on the user device to extract an authentication code stored in a secure vault of the user device, automatically populate the authentication code on the third party device, via the established communication link, and determine that the authentication code matches an entity generated authentication code, wherein the entity generated authentication code is transmitted by the entity associated with the user, determines that the authorization of the communication is successful based on determining that the authentication code matches the entity generated authentication code, and completes the communication initiated by the user, via the third party device.

In some embodiments, the present invention in response to authorizing the communication initiated by the user, extracts device fingerprint associated with the user, generates a confirmation of usage of the authentication code for authorization of the communication, packages the device fingerprint and the confirmation of usage of the authentication code, and transmits the package to the entity associated with the user, wherein the entity utilizes the package to perform post-communication-completion validations.

In some embodiments, the authentication code is first available code of a plurality of authorization codes stored in the secure vault of the user device.

In some embodiments, the present invention causes an entity system associated with the entity to generate the plurality of authorization codes comprising the authentication code based on one or more parameters and transmit the plurality of authorization codes to the user device.

In some embodiments, the present invention causes the entity application in the user device to store the plurality of authorization codes in the secure vault of the user device.

In some embodiments, the present invention determines the one or more parameters based on user information associated with the user.

In some embodiments, the secure vault is a Quantum Key Distribution (QKD) vault.

In some embodiments, the communication is a high exposure communication.

In some embodiments, the communication is initiated in a limited network connectivity environment or a congested network environment.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for usage-based seeding of pre-stored hidden authorization codes for high exposure communications initiated using third party devices in limited network connectivity environments, in accordance with an embodiment of the invention;

FIG. 2 provides a block diagram illustrating the entity system 200 of FIG. 1, in accordance with an embodiment of the invention;

FIG. 3 provides a block diagram illustrating a limited network connectivity authentication system 300 of FIG. 1, in accordance with an embodiment of the invention;

FIG. 4 provides a block diagram illustrating the computing device system 400 of FIG. 1, in accordance with an embodiment of the invention;

FIG. 5 provides a process flow for generating, transmitting, and storing a plurality of authorization codes, in accordance with an embodiment of the invention;

FIG. 6 provides a process flow for usage-based seeding of pre-stored hidden authorization codes for high exposure communications initiated using third party devices in limited network connectivity environments, in accordance with an embodiment of the invention; and

FIG. 7 provides a process flow for performing post-communication-completion validations of high exposure communications initiated by the user, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that is involved in authentication of users for performing communications or interactions. In some embodiments, the entity may be a financial institution which may include herein may include any financial institutions such as commercial banks, thrifts, federal and state savings banks, savings and loan associations, credit unions, investment companies, insurance companies and the like. In some embodiments, the entity may be a non-financial institution. As described herein, a “user” may be an employee, a customer, or a potential customer of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, a quantum computer is any computer that utilizes the principles of quantum physics to perform computational operations. Several variations of quantum computer design are known, including photonic quantum computing, superconducting quantum computing, nuclear magnetic resonance quantum computing, and/or ion-trap quantum computing. Regardless of the particular type of quantum computer implementation, all quantum computers encode data onto qubits. Whereas classical computers encode bits into ones and zeros, quantum computers encode data by placing a qubit into one of two identifiable quantum states. Unlike conventional bits, however, qubits exhibit quantum behavior, allowing the quantum computer to process a vast number of calculations simultaneously.

A qubit can be formed by any two-state quantum mechanical system. For example, in some embodiments, a qubit may be the polarization of a single photon or the spin of an electron. Qubits are subject to quantum phenomena that cause them to behave much differently than classical bits. Quantum phenomena include superposition, entanglement, tunneling, superconductivity, and the like.

Two quantum phenomena are especially important to the behavior of qubits in a quantum computer: superposition and entanglement. Superposition refers to the ability of a quantum particle to be in multiple states at the same time. Entanglement refers to the correlation between two quantum particles that forces the particles to behave in the same way even if they are separated by great distances. Together, these two principles allow a quantum computer to process a vast number of calculations simultaneously.

In a quantum computer with n qubits, the quantum computer can be in a superposition of up to 2ⁿ states simultaneously. By comparison, a classical computer can only be in one of the 2ⁿ states at a single time. As such, a quantum computer can perform vastly more calculations in a given time period than its classical counterpart. For example, a quantum computer with two qubits can store the information of four classical bits. This is because the two qubits will be a superposition of all four possible combinations of two classical bits (00, 01, 10, or 11). Similarly, a three qubit system can store the information of eight classical bits, four qubits can store the information of sixteen classical bits, and so on. A quantum computer with three hundred qubits could possess the processing power equivalent to the number of atoms in the known universe.

Despite the seemingly limitless possibilities of quantum computers, present quantum computers are not yet substitutes for general purpose computers. Instead, quantum computers can outperform classical computers in a specialized set of computational problems. Principally, quantum computers have demonstrated superiority in solving optimization problems. Generally speaking, the term “optimization problem” as used throughout this application describe a problem of finding the best solution from a set of all feasible solutions. In accordance with some embodiments of the present invention, quantum computers as described herein are designed to perform adiabatic quantum computation and/or quantum annealing. Quantum computers designed to perform adiabatic quantum computation and/or quantum annealing are able to solve optimization problems as contemplated herein in real time or near real time.

Embodiments of the present invention make use of quantum ability of optimization by utilizing a quantum computer in conjunction with a classical computer. Such a configuration enables the present invention to take advantage of quantum speedup in solving optimization problems, while avoiding the drawbacks and difficulty of implementing quantum computing to perform non-optimization calculations. Examples of quantum computers that can be used to solve optimization problems parallel to a classic system are described in, for example, U.S. Pat. Nos. 9,400,499, 9,207,672, each of which is incorporated herein by reference in its entirety.

Typically, authorization of communications is performed via real-time transmission of One Time Passcodes (OTP) or One Time Authorization Codes (OTAC) to user devices of users via network carriers associated with the users. However, real-time transmission of One Time Passcodes or One Time Authorization Codes may not always be successful which is not desirable. In addition, multiple systems involved in communications have to be in stand by mode while there is a delay in transmission of OTP or OTAC due to limited network connectivity or network congestion associated with the network carriers, thereby causing inefficient usage of processing power of the systems. As such, there exists a need for a system to overcome the technical problem and can authorize communications initiated by a user in limited connectivity environments. The system of the present invention solves this problem as discussed in detail below.

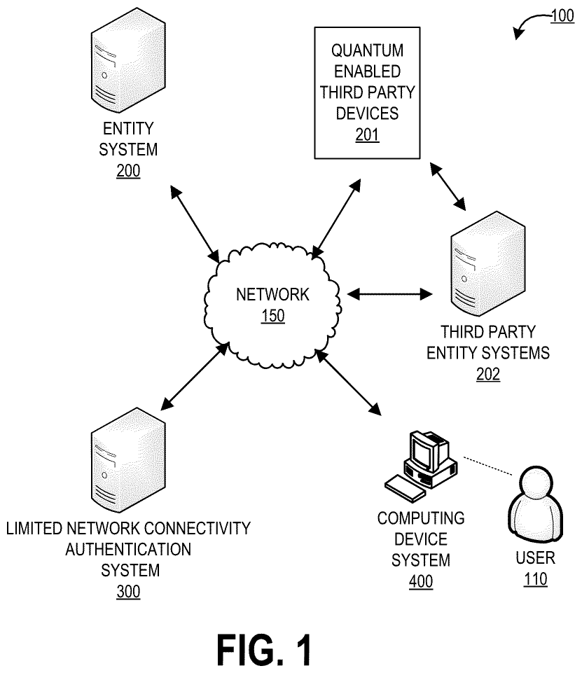

FIG. 1 provides a block diagram illustrating a system environment 100 for usage-based seeding of pre-stored hidden authorization codes for high exposure communications initiated using third party devices in limited network connectivity environments, in accordance with an embodiment of the invention. As illustrated in FIG. 1, the environment 100 includes an limited network connectivity authentication system 300 interacting with a quantum optimizer, an entity system 200, a computing device system 400, quantum enabled third party devices 201, and third party entity systems 202. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some embodiments, the one or more users 110 may be potential customers of the entity associated with the entity system 200. In some embodiments, the one or more users 110 may be employees of the entity associated with the entity system 200.

The entity system(s) 200 may be any system owned or otherwise controlled by an entity to support or perform one or more process steps described herein. In some embodiments, the entity may be any organization that is involved in authentication of users for performing communications or interactions. In some embodiments, the entity is a financial institution. In some embodiments, the entity is a non-financial institution. In some embodiments, the quantum enabled third party devices are any devices that may be used to initiate communications with third party entities and/or the entity. Third party entities may be any organizations that provide goods, services, products, and/or the like to the users 110, where the users 110 interact with the quantum enabled third party devices 201 associated with the third party entities at third party entity locations to initiate communications associated with the acquisition of the products, goods, services, and/or the like provided by the third party entities. In some embodiments, the third party entity systems 202 may be any systems associated with the third party entities that are associated with communicating with the entity systems 200 and/or the limited network connectivity authentication system 300 for processing and/or completing the communications initiated by the users 110 via the quantum enabled third party devices 201. In some embodiments, “communications” described herein may be transactions or interactions initiated by the users 110, where processing or completion of transactions may comprise transfer of resources from a resource pool of a user that is managed by the entity associated with the entity system 200 to a resource pool associated with the third party entity associated with the quantum enabled third party device 201. In some embodiments, the quantum enabled third party devices 201 may be quantum enabled POS devices, quantum enabled kiosks, quantum enabled computing devices, and/or the like present at third party entity locations to initiate communications. In some embodiments, quantum enabled devices described herein may comprise specialized hardware components and specialized software components that implement quantum mechanics based phenomena to allow manipulation and measurement of quantum states, and/or the like.

The limited network connectivity authentication system 300 is a system of the present invention for performing one or more process steps described herein. In some embodiments, the limited network connectivity authentication system 300 may be an independent system. In some embodiments, the limited network connectivity authentication system 300 may be a part of the entity system 200. In some embodiments, the limited network connectivity authentication system 300 may be controlled, owned, managed, and/or maintained by the entity associated with the entity system 200. In some embodiments, an exemplary quantum optimizer can be used in parallel with the limited network connectivity authentication system 300 to solve optimization problems is presented. Each of the systems and devices of the environment 100 may communicate with the quantum optimizer to encrypt or decrypt communications using quantum cryptography for transmissions. In some embodiments, some, more, or all of the communications described herein may take place through the quantum communication channel.

The limited network connectivity authentication system 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the limited network connectivity authentication system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the limited network connectivity authentication system 300, and/or entity system 200 across the network 150. In some embodiments, the computing device system 400 may comprise one or more hardware components and/or one or more software components to implement the Quantum Key Distribution (QKD) cryptography associated with authorization codes as described herein. In some embodiments, the one or more hardware components and/or the one or more hardware components associated with implementing the Quantum Key Distribution (QKD) cryptography may be in communication with the entity system 200, the limited network connectivity authentication system 300, quantum optimizer that is associated with the limited network connectivity authentication system 300, and/or the like to implement the Quantum Key Distribution (QKD) cryptography associated with the authorization codes described herein.

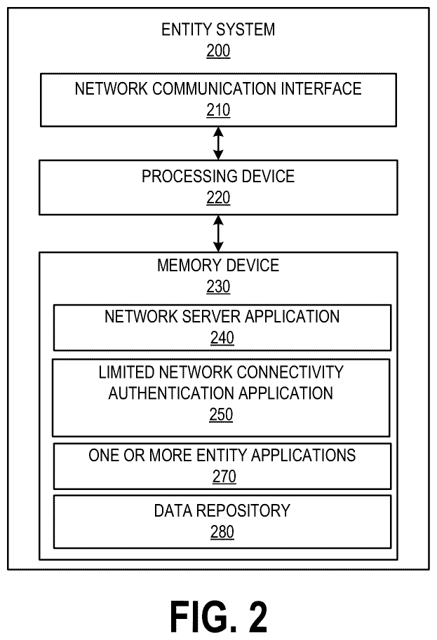

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution or a non-financial institution.

It should be understood that the memory device 230 may include one or more databases or other data structures/repositories. The memory device 230 also includes computer-executable program code that instructs the processing device 220 to perform one or more processing functionalities described herein and also to operate the network communication interface 210 to perform certain communication functions of the entity system 200 described herein. For example, in one embodiment of the entity system 200, the memory device 230 includes, but is not limited to, an limited network connectivity authentication application 250, one or more entity applications 270, and a data repository 280. The one or more entity applications 270 may be any applications developed, supported, maintained, utilized, and/or controlled by the entity. The computer-executable program code of the network server application 240, the limited network connectivity authentication application 250, the one or more entity application 270 to perform certain logic, data-extraction, and data-storing functions of the entity system 200 described herein, as well as communication functions of the entity system 200.

The network server application 240, the limited network connectivity authentication application 250, and the one or more entity applications 270 are configured to store data in the data repository 280 or to use the data stored in the data repository 280 when communicating through the network communication interface 210 with the limited network connectivity authentication system 300, and/or the computing device system 400 to perform one or more process steps described herein. In some embodiments, the entity system 200 may receive instructions from the limited network connectivity authentication system 300 via the limited network connectivity authentication application 250 to perform certain operations. The limited network connectivity authentication application 250 may be provided by the limited network connectivity authentication system 300. The one or more entity applications 270 may be any of the applications used, created, modified, facilitated, developed, and/or managed by the entity system 200.

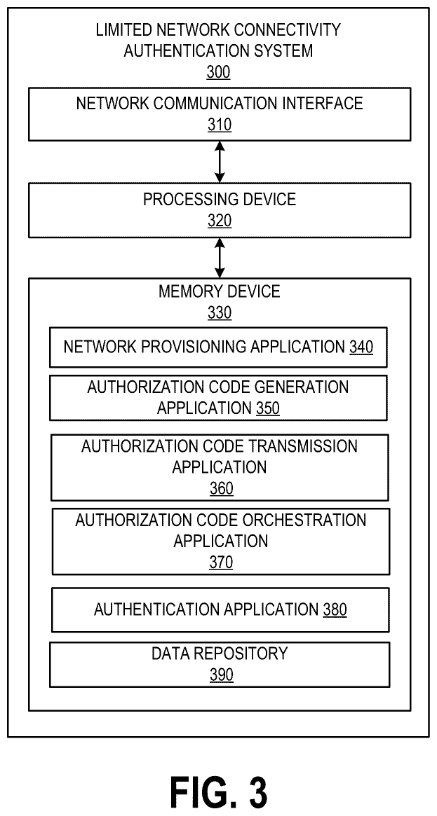

FIG. 3 provides a block diagram illustrating the limited network connectivity authentication system 300 in greater detail, in accordance with embodiments of the invention. As illustrated in FIG. 3, in one embodiment of the invention, the limited network connectivity authentication system 300 includes one or more processing devices 320 operatively coupled to a network communication interface 310 and a memory device 330. In certain embodiments, the limited network connectivity authentication system 300 is operated by an entity, such as a financial institution. In some embodiments, the limited network connectivity authentication system 300 is owned or operated by the entity of the entity system 200. In some embodiments, the limited network connectivity authentication system 300 may be an independent system. In alternate embodiments, the limited network connectivity authentication system 300 may be a part of the entity system 200.

It should be understood that the memory device 330 may include one or more databases or other data structures/repositories. The memory device 330 also includes computer-executable program code that instructs the processing device 320 to perform processing operations described herein and to operate the network communication interface 310 to perform certain communication functions of the limited network connectivity authentication system 300. For example, in one embodiment of the limited network connectivity authentication system 300, the memory device 330 includes, but is not limited to, a network provisioning application 340, an authorization code generation application 350, an authorization code transmission application 360, an authorization code orchestration engine 370, an authentication application 380, and a data repository 390 comprising any data processed or accessed by one or more applications in the memory device 330. The computer-executable program code of the network provisioning application 340, the authorization code generation application 350, the authorization code transmission application 360, the authorization code orchestration engine 370, and the authentication application 380 may instruct the processing device 320 to perform certain logic, data-processing, and data-storing functions of the limited network connectivity authentication system 300 described herein, as well as communication functions of the limited network connectivity authentication system 300.

The network provisioning application 340, the authorization code generation application 350, the authorization code transmission application 360, the authorization code orchestration engine 370, and the authentication application 380 are configured to invoke or use the data in the data repository 390 when communicating through the network communication interface 310 with the entity system 200, and/or the computing device system 400. In some embodiments, the network provisioning application 340, the authorization code generation application 350, the authorization code transmission application 360, the authorization code orchestration engine 370, and the authentication application 380 may store the data extracted or received from the entity system 200, and the computing device system 400 in the data repository 390. In some embodiments, the network provisioning application 340, the authorization code generation application 350, the authorization code transmission application 360, the authorization code orchestration engine 370, and the authentication application 380 may be a part of a single application (e.g., modules).

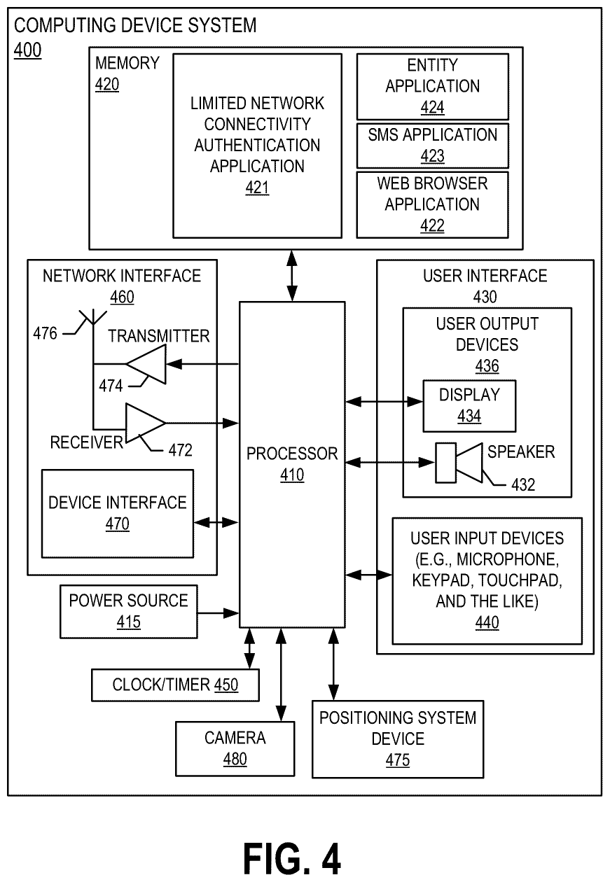

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a limited network connectivity authentication application 421, entity application 424. These applications also typically instructions to a graphical user interface (GUI) on the display 430 that allows the user 110 to interact with the entity system 200, the limited network connectivity authentication system 300, and/or other devices or systems. The memory 420 of the computing device system 400 may comprise a Short Message Service (SMS) application 423 configured to send, receive, and store data, information, communications, alerts, and the like via the wireless network. In some embodiments, the limited network connectivity authentication application 421 provided by the limited network connectivity authentication system 300 allows the user 110 to access the limited network connectivity authentication system 300. In some embodiments, the entity application 424 provided by the entity system 200 and the limited network connectivity authentication application 421 allow the user 110 to access the functionalities provided by the limited network connectivity authentication system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

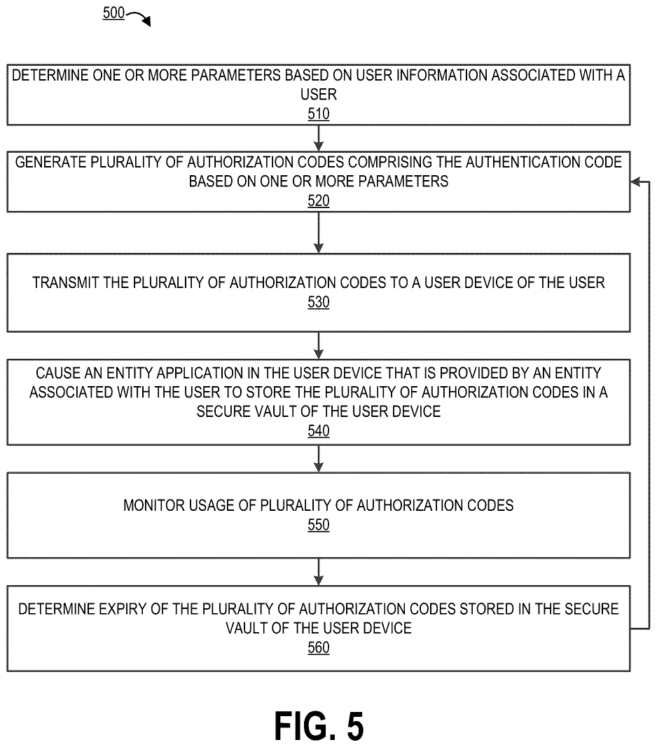

FIG. 5 provides a process flow for generating, transmitting, and storing a plurality of authorization codes, in accordance with an embodiment of the invention. As shown in block 510, the system determines one or more parameters based on user information associated with a user. The one or more parameters may be parameters that are used for generating a plurality of authorization codes that are used in authorizing communications initiated by the user or authenticating the user. In some embodiments, the system may extract user information from the entity system 200. In some embodiments, some of the one or more parameters may also be based on entity data of an entity associated with the user or the communications initiated by the user. In such embodiments, the system may extract entity data from the entity system 200, where the entity data may comprise rules associated with at least communications that are processed by the entity. The one or more parameters may be associated with strength of plurality of authorization codes, expiration of plurality of authorization codes, time of generation of plurality of authorization codes, number of plurality of authorization codes, and/or the like. In one example, the system may determine that a user may initiate five communications per day based on historical data and may set the number of plurality of authorization codes needed for the day to at least five, where the system may later cause the entity system to generate at least five authorization codes based on the number of plurality of authorization codes parameter determined by the system. In another example, the system may determine based on the entity data that expiry of authorization codes to be one day based on entity rules associated with the entity and the system may set the expiration of the plurality of authorization codes as one day.

As shown in block 520, the system generates plurality of authorization codes comprising the authentication code based on one or more parameters. The authorization codes generated by the system may be numeric, alphanumeric, symbolic, alphabetic, uppercase only, lowercase only, hexadecimal, Unicode characters, passphrases, and/or a combination thereof. In some embodiments, where the user is initiating communications using a user device which may be a virtual reality or augmented reality or mixed reality device, the system may generate the plurality of authorization codes that are applicable to such environments. In some embodiments, where the system is integrated into the entity system 200, the system performs one or more steps described in the process flow 500. In some embodiments, where the system is a standalone system linked with the entity system 200, the system may cause the entity system 200 to perform the one or more steps (e.g., any of the steps 520 through 560) described herein by transmitting one or more control signals in real-time to the entity system 200 (via the limited network connectivity authentication application 250).

As shown in block 530, the system transmits the plurality of authorization codes to a user device of the user. In some embodiments, the system may transmit the plurality of authorization codes to the user device of the user based on the one or more parameters. For example, the system may determine a parameter associated with timing generation of the plurality of authorization codes as every day at 5:00 AM and the system may generate and instantaneously transmit the plurality of authorization codes to the user device at 5:00 AM.

As shown in block 540, the system causes an entity application in the user device that is provided by an entity associated with the user to store the plurality of authorization codes in a secure vault of the user device. In some embodiments, the secure vault is a Quantum Key Distribution (QKD) vault. The QKD vault ensures confidentiality of the authorization codes generated via QKD protocols, which are essential for encrypting data. A QKD vault implements additional security measures to prevent unauthorized access or tampering with the authorization codes, thereby enhancing the overall security of the process described herein.

As shown in block 550, the system monitors usage of plurality of authorization codes. The system monitor and track usage of the plurality of authorization codes for the authorization of communications initiated by the user.

As shown in block 560, the system determines expiry of the plurality of authorization codes stored in the secure vault of the user device. The system may determine that all plurality of authorization codes are used by the user for the authorization of communications initiated by the user and the process flow proceeds to block 520, where the plurality of authorization codes are generated. In some embodiments, the system may detect a number of unsuccessful authentication attempts associated with the user and may cause the entity application in the user device to erase the plurality of authorization codes from the secure vault. In such embodiments, the system may update one or more features of the secure vault, generate new plurality of authorization codes, and store the new plurality of authorization codes in the updated secure vault.

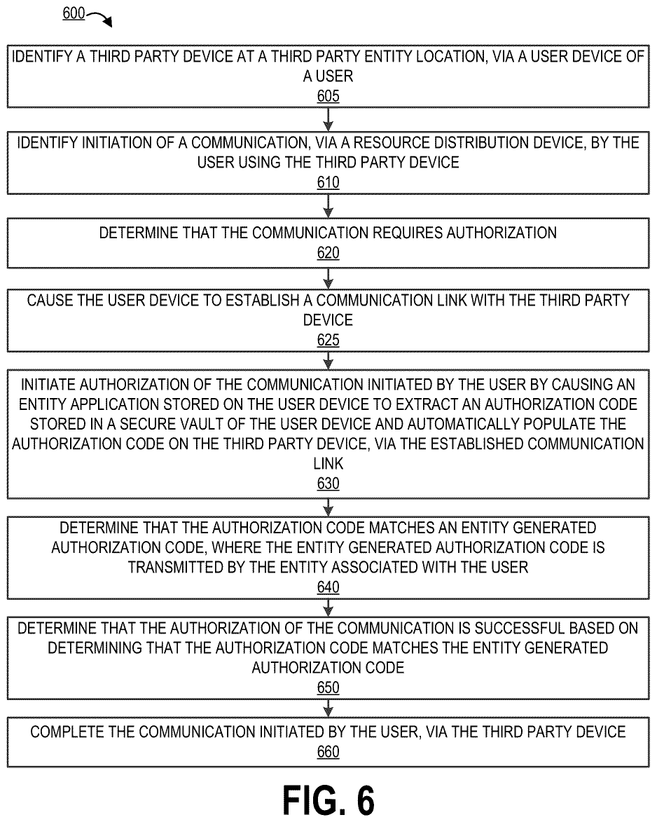

FIG. 6 provides a process flow for usage-based seeding of pre-stored hidden authorization codes for high exposure communications initiated using third party devices in limited network connectivity environments, in accordance with an embodiment of the invention. In some embodiments, where the system is integrated into the entity system 200, the system performs one or more steps described in the process flow 600. In some embodiments, where the system is a standalone system linked with the entity system 200, the system may cause the entity system 200 to perform the one or more steps (e.g., any of the steps 610 through 660) described herein by transmitting one or more control signals in real-time to the entity system 200 (via the limited network connectivity authentication application 250).

As shown in block 605, the system identifies a third party device at a third party entity location, via a user device of a user. The third party device may be any device at a third party entity location that may be managed, controlled, owned, and/or operated by a third party entity. In some embodiments, the third party entity device is a quantum enabled third party entity device. In some embodiments, the system may identify the presence of the third party device, via one or more components of the user device. In some such embodiments, the system may store instructions on the user device, via the entity application 424 or the limited network connectivity authentication application 421, where the instructions cause the user device to scan presence of quantum enabled third party devices. For example, the user may walk into a third party entity location and based on the location, the user device may initiate scanning for presence of third party devices. In another example, the user device based on the instructions provided by the system may continuously scan for third party devices.

As shown in block 610, the system identifies initiation of a communication, via a resource distribution device, by the user using the third party device. In some embodiments, the communication may be a financial transaction, secure authentication request to login to an account of the user, password recovery or account recovery, corporate access control, social media platforms, and/or any communication that requires a One Time Password (OTP) or One Time Authorization Codes. In some specific embodiments of the invention, the communication may be a financial transaction for acquisition of products, goods, services, and/or the like provided by a third party entity at the third party entity location. The resource distribution device may be a credit card, debit card, digital wallet, and/or the like. In one example, the user may swipe a credit card at the quantum enabled third party device and the system may identify the card swipe based on receiving a communication from components of the credit card, monitoring the third party device, receiving a communication from the third party device, and/or the like.

As shown in block 620, the system determines that the communication requires authorization. The system may determine based on a type of the communication, that the communication initiated by the user requires authorization using a One Time Password (OTP) or One Time Authorization Code.

As shown in block 625, the system causes the user device to establish a communication link with the third party device. In some embodiments, the communication link may be pairing of the user device and the third party device. In some embodiments, the communication link may be established via Near Field Communication (NFC) technology.

As shown in block 630, the system initiates authorization of the communication initiated by the user by causing an entity application stored on the user device to extract an authorization code stored in a secure vault of the user device and automatically populate the authorization code on the third party device, via the established communication link. In some embodiments, the system may extract the first available authorization code and automatically populate the authorization code on the third party device. In some embodiments, extraction of the authorization codes is in a First In First Out order.

As shown in block 640, the system determines that the authorization code matches an entity generated authorization code, where the entity generated authorization code is transmitted by the entity associated with the user (as explained in FIG. 5). In some embodiments, the system may verify that the authorization code populated on the third party device matches the entity generated authorization code.

As shown in block 650, the system determines that the authorization of the communication is successful based on determining that the authorization code matches the entity generated authorization code. As shown in block 660, the system completes the communication initiated by the user, via the third party device.

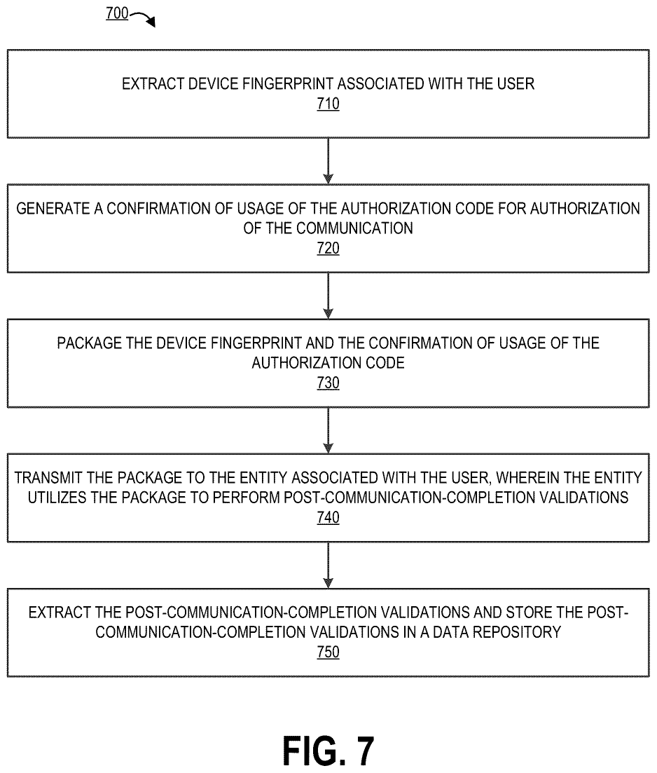

FIG. 7 provides a process flow for performing post-communication-completion validations of high exposure communications initiated by the user, in accordance with an embodiment of the invention. As shown in block 710, the system extracts device fingerprint associated with the user. The device fingerprint may be a unique fingerprint of the user device (e.g., unique identification number, IMEI number, and/or the like).

As shown in block 720, the system generates a confirmation of usage of the authorization code for authorization of the communication. The system may generate a notification comprising information associated with the communication that the authorization code was used for (e.g., information associated with the platform, time of initiation of the communication, time of completion of the communication, and/or the like).

As shown in block 730, the system packages the device fingerprint and the confirmation of usage of the authorization code. As shown in block 740, the system transmits the package to the entity associated with the user, wherein the entity utilizes the package to perform post-communication-completion validations. Post-communication-completion validation may comprise comparing the device fingerprint in the package with stored device fingerprint, where the stored device fingerprint may collected during registration of the user with the entity system (e.g., opening of an account, and/or the like). Post-communication-completion validation may be performed by the system to take one or more mitigation steps in case where the authorization was not performed by the user. As shown in block 750, the system extracts the post-communication-completion validations and store the post-communication-completion validations in a data repository.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| | application | | |
| Docket Number | Ser. No. | Title | Filed On |
| 17119US01.014033.5236 | To be assigned | SYSTEM AND METHOD FOR USAGE- | Concurrently |
| | | BASED SEEDING OF PRE-STORED | herewith |
| | | HIDDEN AUTHORIZATION CODES | |
| | | FOR HIGH EXPOSURE | |
| | | COMMUNICATIONS INITIATED | |
| | | USING USER DEVICES IN LIMITED | |
| | | NETWORK CONNECTIVITY | |
| | | ENVIRONMENTS | |

1. A system for usage-based seeding of pre-stored hidden authorization codes for high exposure communications initiated using third party devices in limited network connectivity environments, the system comprising:
at least one network communication interface;
at least one non-transitory storage device; and
at least one processing device coupled to the at least one non-transitory storage device and the at least one network communication interface, wherein the at least one processing device is configured to:
identify a third party device at a third party entity location, via a user device of a user;
identify initiation of a communication, via a resource distribution device, by the user using the third party device;
determine that the communication requires authorization;
cause the user device to establish a communication link with the third party device;
initiate authorization of the communication initiated by the user by causing an entity application provided by an entity associated with the user that is stored on the user device to:
extract an authentication code stored in a secure vault of the user device;
automatically populate the authentication code on the third party device, via the established communication link; and
determine that the authentication code matches an entity generated authentication code, wherein the entity generated authentication code is transmitted by the entity associated with the user;
determine that the authorization of the communication is successful based on determining that the authentication code matches the entity generated authentication code; and
complete the communication initiated by the user, via the third party device.

2. The system of claim 1, wherein the at least one processing device is configured to:
in response to authorizing the communication initiated by the user, extract device fingerprint associated with the user;
generate a confirmation of usage of the authentication code for authorization of the communication;
package the device fingerprint and the confirmation of usage of the authentication code; and
transmit the package to the entity associated with the user, wherein the entity utilizes the package to perform post-communication-completion validations.

3. The system of claim 1, wherein the authentication code is first available code of a plurality of authorization codes stored in the secure vault of the user device.

4. The system of claim 3, wherein the at least one processing device is configured to cause an entity system associated with the entity to:
generate the plurality of authorization codes comprising the authentication code based on one or more parameters; and
transmit the plurality of authorization codes to the user device.

5. The system of claim 4, wherein the at least one processing device is configured to cause the entity application in the user device to store the plurality of authorization codes in the secure vault of the user device.

6. The system of claim 4, wherein the at least one processing device is configured to determine the one or more parameters based on user information associated with the user.

7. The system of claim 1, wherein the secure vault is a Quantum Key Distribution (QKD) vault.

8. The system of claim 7, wherein the communication is a high exposure communication.

9. The system of claim 1, wherein the communication is initiated in a limited network connectivity environment or a congested network environment.

10. A computer program product for usage-based seeding of pre-stored hidden authorization codes for high exposure communications initiated using third party devices in limited network connectivity environments, the computer program product comprising a non-transitory computer-readable storage medium having computer executable instructions for causing a computer processor to perform the steps of:
identifying a third party device at a third party entity location, via a user device of a user;
identifying initiation of a communication, via a resource distribution device, by the user using the third party device;
determining that the communication requires authorization;
causing the user device to establish a communication link with the third party device;
initiating authorization of the communication initiated by the user by causing an entity application provided by an entity associated with the user that is stored on the user device to:
extract an authentication code stored in a secure vault of the user device;
automatically populate the authentication code on the third party device, via the established communication link; and
determine that the authentication code matches an entity generated authentication code, wherein the entity generated authentication code is transmitted by the entity associated with the user;
determining that the authorization of the communication is successful based on determining that the authentication code matches the entity generated authentication code; and
completing the communication initiated by the user, via the third party device.

11. The computer program product of claim 10, wherein the computer executable instructions cause the computer processor to perform the steps of:
in response to authorizing the communication initiated by the user, extracting device fingerprint associated with the user;
generating a confirmation of usage of the authentication code for authorization of the communication;
packaging the device fingerprint and the confirmation of usage of the authentication code; and
transmitting the package to the entity associated with the user, wherein the entity utilizes the package to perform post-communication-completion validations.

12. The computer program product of claim 10, wherein the authentication code is first available code of a plurality of authorization codes stored in the secure vault of the user device.

13. The computer program product of claim 12, wherein the computer executable instructions cause the computer processor to perform the steps of causing an entity system associated with the entity to:
generate the plurality of authorization codes comprising the authentication code based on one or more parameters; and
transmit the plurality of authorization codes to the user device.

14. The computer program product of claim 13, wherein the computer executable instructions cause the computer processor to perform the steps of causing the entity application in the user device to store the plurality of authorization codes in the secure vault of the user device.

15. The computer program product of claim 13, wherein the computer executable instructions cause the computer processor to perform the step of determining the one or more parameters based on user information associated with the user.

16. A computer implemented method for usage-based seeding of pre-stored hidden authorization codes for high exposure communications initiated using third party devices in limited network connectivity environments, wherein the method comprises:
identifying a third party device at a third party entity location, via a user device of a user;
identifying initiation of a communication, via a resource distribution device, by the user using the third party device;
determining that the communication requires authorization;
causing the user device to establish a communication link with the third party device;
initiating authorization of the communication initiated by the user by causing an entity application provided by an entity associated with the user that is stored on the user device to:
extract an authentication code stored in a secure vault of the user device;
automatically populate the authentication code on the third party device, via the established communication link; and
determine that the authentication code matches an entity generated authentication code, wherein the entity generated authentication code is transmitted by the entity associated with the user;
determining that the authorization of the communication is successful based on determining that the authentication code matches the entity generated authentication code; and
completing the communication initiated by the user, via the third party device.

17. The computer implemented method of claim 16, wherein the method comprises:
in response to authorizing the communication initiated by the user, extracting device fingerprint associated with the user;
generating a confirmation of usage of the authentication code for authorization of the communication;
packaging the device fingerprint and the confirmation of usage of the authentication code; and
transmitting the package to the entity associated with the user, wherein the entity utilizes the package to perform post-communication-completion validations.

18. The computer implemented method of claim 16, wherein the authentication code is first available code of a plurality of authorization codes stored in the secure vault of the user device.

19. The computer implemented method of claim 18, wherein the method comprises causing an entity system associated with the entity to:
generate the plurality of authorization codes comprising the authentication code based on one or more parameters; and
transmit the plurality of authorization codes to the user device.

20. The computer implemented method of claim 18, wherein the method comprises causing the entity application in the user device to store the plurality of authorization codes in the secure vault of the user device.
